(19) United States
(12) Patent Application Publication
(10) Pub. No.: US 2008/0087720 A1
(43) Pub. Date: Apr. 17, 2008

(54) Biometric Access Control System for Vending Machines

(76) Inventor: Yevgeny Boris Levitov, San Antonio, TX (US)

Correspondence Address: ERIC W. CERNYAR, P.C., 1122 GOLDEN CYCLE CIRCLE, CRIPPLE CREEK, CO, 80813, US

(21) Appl. No.: 11/548,566

(22) Filed: Oct. 11, 2006

(51) Int. Cl. G07F 19/00; G06F 7/08; G06K 5/00

(52) U.S. Cl. 235/379; 235/381; 235/382

(57) ABSTRACT

A biometric access control system and method for currency-handling machines such as merchandise vending machines, payphones, copy machines, video game machines, pool and pin-ball machines, slot machines, parking meters, and automatic teller machines has two principal components—a digital authentication device (“DAD”) that is installed within the currency-handling machine, and a mobile biometric data collection device (“MDCD”) that a currency-handling machine servicer takes with him or her along his or her currency-collection route. In operation, a previously-collected reference biometric template for a servicer is stored on the MDCD and compared with a fresh biometric sample taken by a biometric sensor built into the MDCD. An authenticated servicer is then provided with access to the currency-handling machine. Preferably, the MDCD also maintains an audit trail of the time and location of each access attempt and the identity of the servicer.

### FIELD OF THE INVENTION

This invention relates generally to biometric access control systems, and more particularly to biometric access control systems for merchandise, service, and amusement vending machines.

### BACKGROUND OF THE INVENTION

Several enterprises rely on widely distributed self-service currency-collecting vending machines to dispense goods or provide services or amusement. These vending machines must be maintained and/or restocked, and the money collected therefrom, on a regular basis. Large enterprises frequently hire individuals—hearafter referred to as “vending machine servicers” or simply “servicers”—who drive along their vending machine routes to perform these tasks on a regular basis. Unfortunately, fraud is common. Some servicers pocket some of the money they collect or steal or fail to stock the machines with all of the represented merchandise. And frequently, these vending machines lack adequate technology for identifying the fraud or for identifying the particular servicer who committed the fraud.

### SUMMARY OF THE INVENTION

To reduce the occurrence of fraud by vending machine servicers, the inventor has developed a biometric access control system and method for currency-handling machines. The biometric access control system comprises two principal components—a digital authentication device (“DAD”) that is installed within the currency-handling machine, and a mobile biometric data collection device that a servicer takes with him or her along his or her vending machine route. The DAD is connected to and controls the operation of the currency-handling machine's electronic lock mechanism (e.g., a magnetic lock). In operation, one or more previously-collected reference biometric templates for a servicer, or for multiple servicers, are stored on the mobile biometric data collection device. The mobile biometric data collection device also includes one or more biometric sensors—such as a fingerprint reader, camera, iris scanner, voice recording module, or signature reader—for obtaining a fresh biometric sample from the servicer.

In one embodiment, the mobile biometric data collection device transfers both a reference biometric template, in encrypted form, and the freshly sensed biometric sample, also in encrypted form, to the DAD, which decrypts the data, performs the comparison, authenticates the servicer, and unlocks a service door or panel to provide the servicer with access to the machine, and to the currency repository (e.g., coin and/or cash box(es)) inside the machine. In another embodiment, the mobile biometric data collection device performs a biometric comparison on board the mobile biometric data collection device and, if a high-confidence match is found, transfers an encrypted key to the DAD, which then authenticates the key and unlocks a service door or panel to provide the servicer with access to the machine. The transfer of information between the mobile biometric data collection device and the DAD may be either wired or wireless.

In more detailed embodiments, the mobile biometric data collection device also includes a memory, a clock, and optionally (or alternatively to the clock) a GPS receiver, for storing audit information. Every time an attempt is made to use the mobile biometric data collection device by providing a biometric scan, a record is stored in memory of the clock-provided time (or alternatively the GPS-recorded time) and either an indicator of the identity of the servicer (e.g., a name, an identification number or the biometric sample obtained from the servicer) who attempted to use the mobile biometric data collection device. In GPS-receiver-equipped embodiments, a record is also made of the GPS-recorded place where the attempt was made. Furthermore, the mobile biometric data collection device's memory maintains a log of communications between itself and a DAD. Preferably, the DAD is equipped to communicate an identifier to the mobile biometric data collection device, so that the mobile biometric data collection device can also log the identifier of the DAD in conjunction with its audit trail of any use of the mobile biometric data collection device.

In a yet further developed embodiment, the mobile biometric data collection device also includes a keypad and a digital display (e.g., LCD) screen that prompts a servicer to enter information during each access. Preferably, the mobile biometric data collection device prompts the servicer to enter one or more of the following pieces of information: a password, authorization code, or response to an authentication query; an inventory of the amount of currency (both cash and coins) collected from the currency-handling machine; and an inventory of the merchandise the servicer added to the machine.

In a yet further developed embodiment, the DAD also keeps track of, or is interfaced with a legacy or add-on device installed in the machine that keeps track of, money the currency-handling machine has collected, rejected, or dispensed and merchandise or services the currency-handling machine has dispensed. The DAD (or, alternatively, the legacy or add-on device) then communicates this information as well to the mobile biometric data collection device, so that the statistics that the DAD (or, alternatively, the legacy or add-on device) has collected can be compared with the information that the servicer entered into the mobile biometric data collection device.

The inventor's biometric access control system and method can be applied to many types of self-service currency-handling machines, including but not limited to snack and beverage vending machines, coffee and cappuccino vending machines, newspaper and magazine vending boxes, cigarette dispensing machines, postage stamp dispensing machines, payphones, copy machines, video game and arcade game machines, pool and pin-ball machines, gambling machines such as slot machines, jukeboxes, parking meters, automatic teller machines, coin-or-currency-operated photo booths, coin-or-currency-operated Internet kiosks, gumball machines, pay toilets, feminine product dispensers, and novelty item dispensing machines.

### BRIEF DESCRIPTION OF THE DRAWINGS

FIG. 1 is an illustration of one embodiment of a biometric access control system for a currency handling machine.

FIG. 2. is a functional block diagram of one embodiment of a digital authentication device designed for installation inside a currency handling machine.

FIG. 3 is an enlarged view of one embodiment of a mobile biometric data collection device.

FIG. 4 is a block diagram of one embodiment of a mobile biometric data collection device.

FIG. 5 is a flow chart of a method of servicing a currency-handling machine equipped with a currency repository and a digital authentication device adapted to provide access to the currency repository.

FIG. 6 is a block diagram of one embodiment of an enrollment and registration station for a biometric access control system for a currency-handling machine.

### DETAILED DESCRIPTION

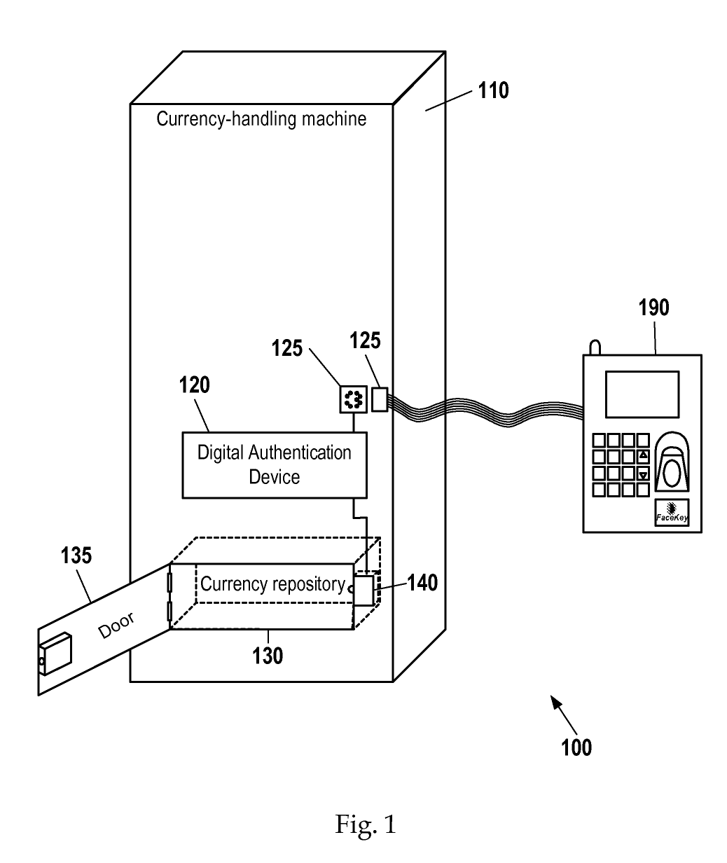

FIG. 1 is an illustration of one embodiment of a biometric access control system 100 for a currency handling machine 110. The biometric access control system 100 comprises a mobile biometric data collection device 190 and one or more digital authentication devices (or “DADs”) 120 that are installed in one or more currency-handling machines 110. The mobile biometric data collection device 190 is used to access a plurality of DAD-equipped currency-handling machines 110 along a service route.

The currency-handling machine 110 could be, for example, a snack or beverage vending machine; a coffee or cappuccino vending machine, a newspaper or magazine vending box, a cigarette dispensing machine, a postage stamp dispensing machine, a payphone, a copy machine, a video game or arcade game machine, a pool or pin-ball machine, a gambling machine such as a slot machine, a jukebox, a parking meter, an automatic teller machine, a coin-or-currency-operated photo booth, a coin-or-currency-operated Internet kiosk, a gumball machine, a pay toilet, a feminine product dispenser, a novelty item dispensing machine, or a cash register.

Typically, the currency-handling machine 110 comprises a currency repository 130 that holds currency received and/or dispensed by the currency-handling machine 110 and a door or panel 135 that, when opened or removed, provides access to the currency repository or cassette 130. The door or panel 135 may either be a door or panel mounted on the frame of the currency-handling machine 110 or a door or panel mounted directly on the currency repository or cassette 130. To adapt the currency-handling machine 110 to biometric access control, a DAD 120 is installed within the currency-handling machine 110 and connected to an electronic lock mechanism 140 operable to unlock the door or panel 135 to thereby provide a servicer attempting to obtain access to the currency repository or cassette 130 with access to the currency repository or cassette 130.

In the embodiment shown in FIG. 1, the DAD 120 is communicatively coupled to a communications port or socket 125, which is used to receive communications (such as a biometric reference template and a recently-sensed biometric sample) from a mobile biometric data collection device 190 carried by the servicer. Alternatively, the DAD 120 is equipped with a wireless communications interface (not shown in FIG. 1) to exchange communications with the mobile biometric data collection device 190. The DAD 120 is equipped with a processor that decrypts and processes communications received from the mobile biometric data collection device 190. In embodiments in which the DAD 120 performs the biometric matching routine, the DAD 120 compares the biometric reference template with the sensed biometric sample to authenticate the servicer attempting to obtain access to the currency repository 130. Upon identifying a match, the DAD 120 sends a signal to cause the electronic lock mechanism 140 to unlock the door or panel 135. In embodiments in which the biometric comparison is performed by the mobile biometric data collection device 190 itself, the DAD 120 decrypts a key it receives from the mobile biometric data collection device 190. If the DAD 120 determines that the key is valid, the DAD 120 sends a signal to cause the electronic lock mechanism 140 to unlock the door or panel 135.

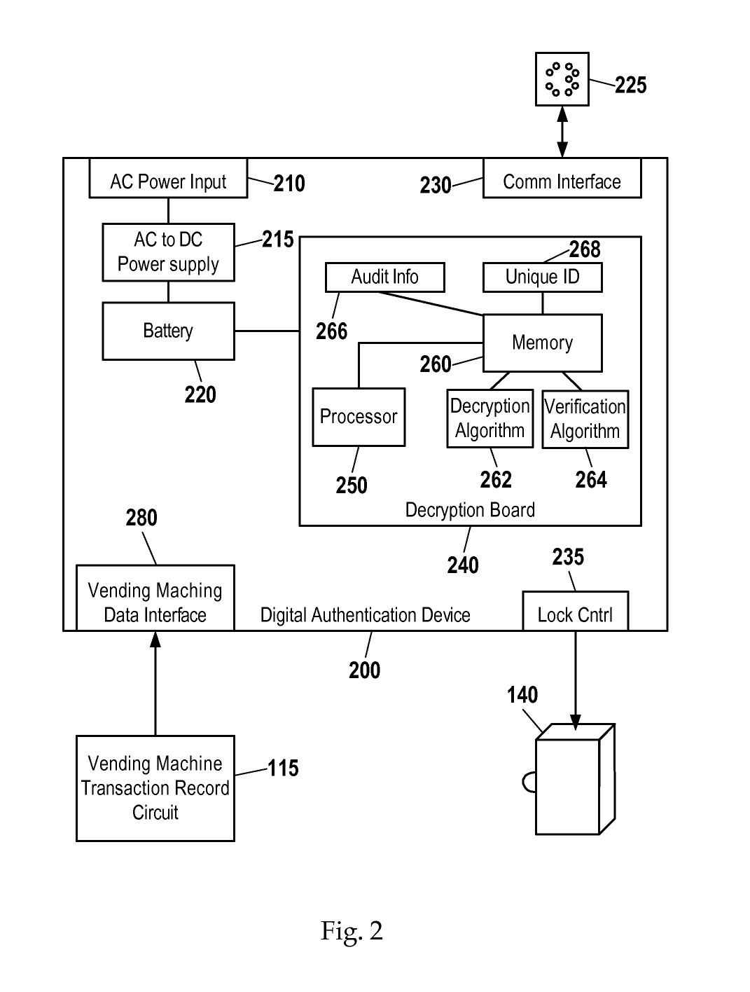

FIG. 2. is a functional block diagram of one embodiment of a DAD 200 designed for installation inside a currency handling machine 110. The DAD 200 includes a wired or wireless communications interface 230 for receiving and/or exchanging communications with a mobile biometric data collection device 190, and a decryption board 240 or decryption circuitry, including a processor 250 and memory 260, for processing those communications and outputting lock control signals via a lock control port 235 designed for connection with an electronic lock mechanism 140. An AC to DC power supply 215, which receives power through an AC power input interface 210, supplies power to the DAD 200. The DAD 200 may also include a battery 220 to provide power during power outages.

The memory 260 on the decryption board 240 is used to store a decryption algorithm or routine 262 and a verification algorithm or routine 264. The decryption algorithm 262 decrypts communications received from the mobile biometric data collection device 190. The verification algorithm or routine 264 is, in some embodiments, a biometric matching routine for comparing a biometric template with a sensed biometric sample, and in other embodiments, an algorithm used to determine whether a key received from a mobile biometric data collection device 190 is valid.

Biometric verification and matching algorithms are well known in the art. For example, U.S. Pat. No. 7,039,221 for a “Facial Image Verification Smart-Card with Integrated Video Camera,” assigned to FaceKey Corporation of San Antonio, Tex., and U.S. Pat. No. 6,963,659 for a “Fingerprint Verification System Utilizing a Facial Image-Based Heuristic Search Method,” also assigned to Facekey Corp., describe fingerprint and facial image recognition methods. U.S. Pat. Nos. 7,039,221 and 6,963,659 are incorporated herein by reference.

The memory 260 may also store a unique ID 268 to identify the DAD 200. In one embodiment, the DAD 200 communicates the unique ID 268 to the mobile biometric data collection device 190 for audit purposes. This unique ID 268 can be matched with currency-handling machine 110, so that records can be collected, on a machine-by-machine basis, of each attempt to obtain service access to a currency-handling machine 110.

In a more advanced embodiment, the DAD 200 includes a communications interface 280 for receiving data concerning the amount of money held in the currency repository 130 from an external vending machine transaction record circuit 155. In this more advanced embodiment, a portion of the memory 260 on board the decryption board 240 of the DAD 200 is allocated to storing audit information 266, including a time-stamped log entry for each attempt to obtain service access and each grant of service access. The log entries would either include a running balance or debit or credit information to enable determination of the amount of money held in the currency repository 130 before and after each service access. Addition audit information 266 may include a time-stamped log entry of each customer coin or currency transaction processed by the currency-handling machine 110.

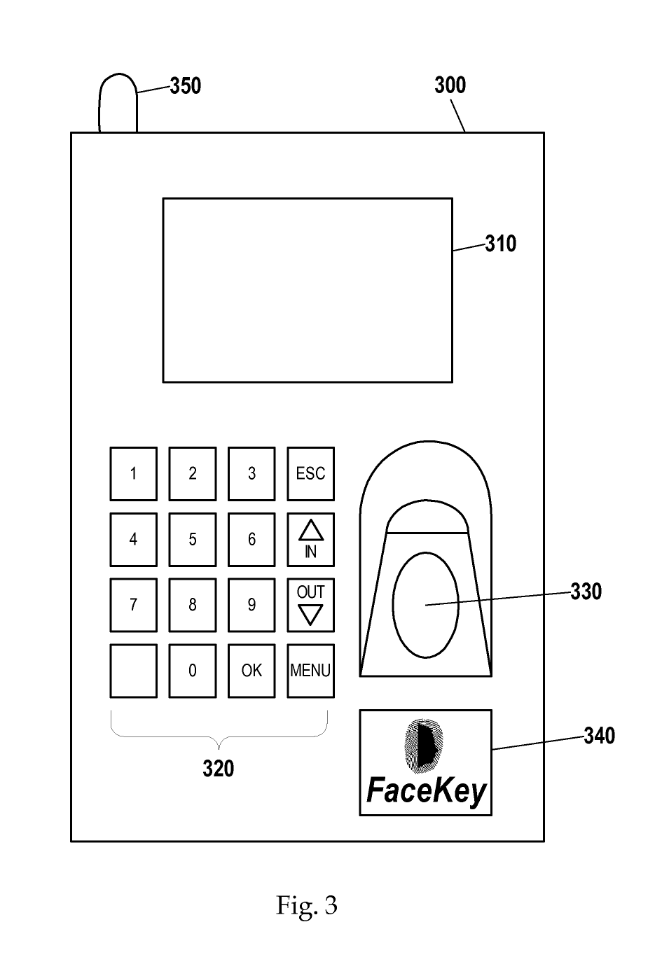

FIG. 3 is an enlarged view of the top face of one embodiment of a mobile biometric data collection device 300. Mobile biometric data collection device 300 comprises a digital display 310 to provide the servicer with information and with which to prompt the servicer to enter information, a keypad 320 enabling the servicer to enter and request information, and a fingerprint sensor 330 or other biometric sensing device, such as a camera for capturing a facial image or scanning an iris, or a microphone for capturing a voice sample. The mobile biometric data collection device 300 optionally includes an antenna 350 to wirelessly communicate information with external devices, such as the DAD 120 of the currency-handling machine 110 and a central administrative station (not shown but discussed below), and a logo 340 to identify the source of the device 300. Another embodiment of mobile biometric data collection device 300 eliminates the keypad 320 and provides a touch-sensitive digital display 310 for entering information and responding to queries. Yet another embodiment of the mobile biometric data collection device 300 prompts the user to write certain words in cursive on the touch-sensitive digital display 310, times the user's cursive entries, and uses time-sensitive handwriting analysis to authenticate the servicer.

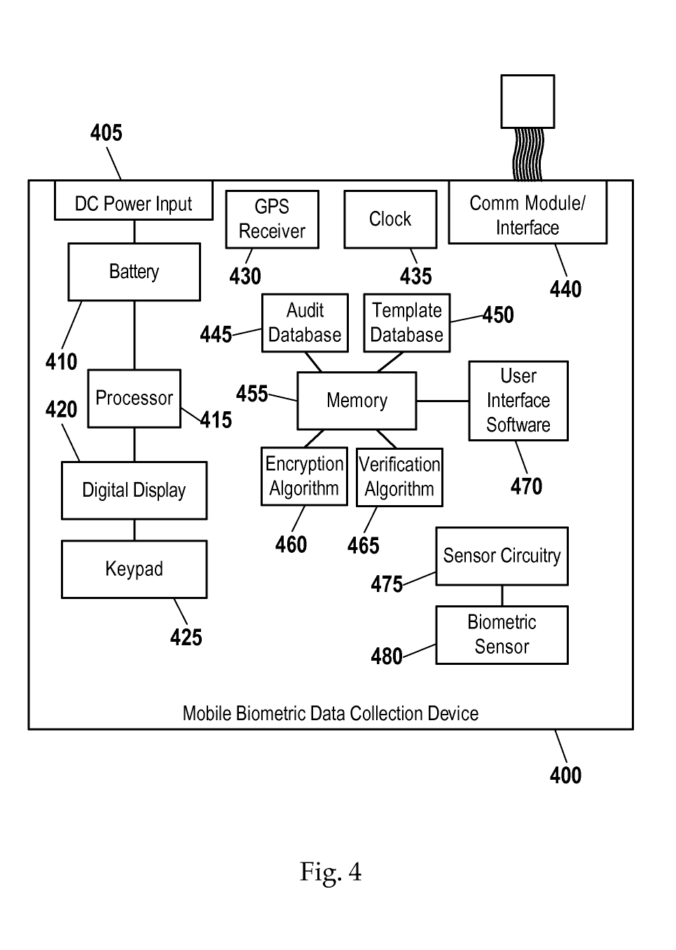

FIG. 4 is a functional block diagram of one embodiment of a mobile biometric data collection device 400. The mobile biometric data collection device 400 comprises a memory module 455, a built-in biometric sensor 480 and sensor circuitry 475 for extracting biometric data from the sensed data, a processor 415, and a wired or wireless communications module and interface 440 operable to communicate information to the DAD 120 of the currency-handling machine 110. The memory module 455 is adapted to retain a single servicer's biometric reference template 450, or alternatively, a database of biometric reference templates 450 of a plurality of currency-handling machine servicers. The biometric sensor 480 is adapted to sense a biometric characteristic of the servicer, for subsequent comparison with the biometric reference template. Information passed through the communications interface 440 is processed by the DAD 120 to provide or deny access to the currency repository 130.

Depending on the embodiment, either one-to-one, one-to-few, or one-to-many biometric comparisons can be carried out. One-to-one and one-to-few comparisons can be facilitated by having the servicer enter a personal identification number that is associated with a particular biometric reference template 450. Furthermore, one-to-one biometric matches can be carried out either by the mobile biometric data collection device 400 or by the DAD 120.

In systems in which matching is carried out by the mobile biometric data collection device 400 (which will typically be the case with one-to-many comparisons), the processor 415 runs a verification algorithm 465 stored in memory 455 to compare one or more biometric reference templates 450 with the sensed biometric characteristic of the servicer. Upon identifying a match, the processor 415 transfers an encrypted key to the digital authentication device for obtaining access to the currency repository. In systems in which matching is carried out by the DAD 120, the processor 415 runs an encryption algorithm 460 to encrypt the sensed biometric characteristic and the biometric reference template 450 before transferring them to the mobile biometric data collection device 400.

The mobile biometric data collection device 400 preferably further comprises a DC power input receptacle 405, a battery 410, a keypad or other user input device 425, and a digital display 420 (e.g., a LCD screen) built into the mobile biometric data collection device 400. The mobile biometric data collection device 400 runs a user interface routine 470 that uses the digital display 420 to prompt the servicer to enter information related to any attempt to access the currency repository 130 of the currency-handling machine 110. Preferably, the mobile biometric data collection device 400 prompts the servicer to enter one or more of the following pieces of information: a password, authorization code, or response to an authentication query; an inventory of the amount of currency (both cash and coins) collected from the currency-handling machine 110; and an inventory of the merchandise the servicer added to the machine 110.

Preferably, the mobile biometric data collection device 400 is equipped to log attempts to access a currency-handling machine 110. Logged information preferably includes an indicator of the identity of a person attempting to access the currency-handling machine 110. This indicator may be biometric information derived from a biometric characteristic of the person sensed by the biometric sensor 480. Alternatively, the indicator is information, such as a confidential personal identification number, entered by the servicer. Logged information may also include the time and/or location of an attempt to access a currency-handling machine 110. Time information may be received from a clock 435 built into the mobile biometric data collection device 400. Alternatively, both time and location information may be received from a GPS receiver 430 communicatively coupled to the mobile biometric data collection device 400. Preferably, the logged information also includes a digital identifier, such as a unique ID 268 received from the DAD 120, of the currency-handling machine 110. In an enhanced embodiment, the mobile biometric data collection device 190 is also operable to receive and store information collected from the DAD 120 concerning the amount of money held in the currency repository 130.

In even more enhanced embodiments of the mobile biometric data collection device 400, the wireless communications module and interface 440 comprises a cell phone communications circuit and antenna, whereby the mobile biometric data collection device 400 can upload access attempt and other information to a central administrative station (not shown) and download new biometric templates and other configuration information from the central administrative station. Alternatively, the wireless communications module and interface 440 attempts to establish a wireless Internet connection if a network connection is available, and access the central administration station via an Internet connection.

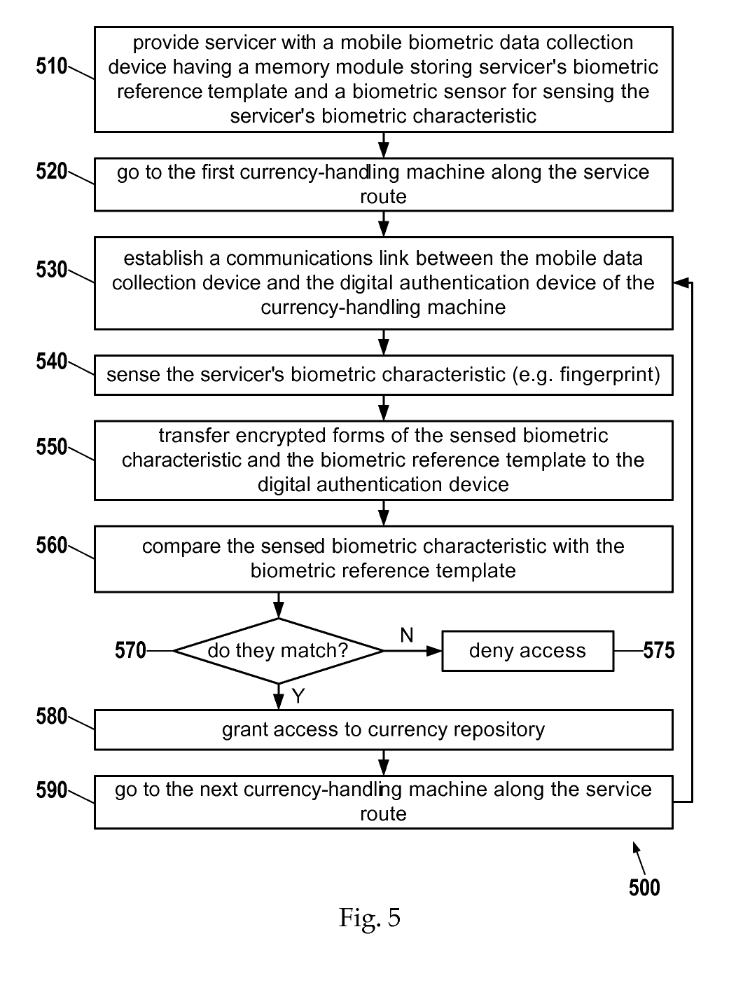

FIG. 5 is a flow chart 500 of a method of servicing a currency-handling machine 110 equipped with a currency repository 130 and a DAD 120 adapted to provide access to the currency repository 130. In block 510, the servicer is provided with a mobile biometric data collection device 400 to carry along his or her service route. The mobile biometric data collection device 400 has a memory module 455 storing a biometric reference template 450 of a currency-handling machine servicer and a biometric sensor 480 adapted to sense a biometric characteristic of the servicer for subsequent comparison with the biometric reference template 450. In block 520, the servicer goes to the first currency-handling machine along the service route. There, in accordance with block 530, the servicer establishes a communications link between the mobile biometric data collection device 400 and the DAD 120 of the currency-handling machine 110. Prior to or after establishing this communications link, the mobile biometric data collection device 400 may query the servicer to enter a personal identification number to doubly authenticate the servicer. The mobile biometric data collection device 400 may also query the servicer to enter information about the transaction he or she intends to make, such as collecting or adding money to the currency repository 130 or stocking the currency-handling machine 110 with goods. For example, the servicer may be prompted to identify how much money and how many and what type of goods were involved in the transaction.

In block 540, the mobile biometric data collection device 400 senses a biometric characteristic, such as a fingerprint or facial profile, from the servicer. In optional block 550, the mobile biometric data collection device 400 transfers encrypted forms of the sensed biometric characteristic and the biometric reference template 450 to the DAD 120 for matching by the DAD 120. Alternatively, the matching is done on board the mobile biometric data collection device 400, in which case the action set forth in block 550 is omitted. In block 560, the sensed biometric characteristic is compared with the biometric reference template. If they match, as illustrated by decision block 570, then in block 580 the servicer is granted access to the currency repository 130. If not, then in block 575, the servicer is denied access to the currency repository 130. In block 590, the servicer goes to the next currency handling machine 110 along his or her service route, and the actions set forth in blocks 530-580 are repeated for each machine 110 along the service route.

Although not illustrated in FIG. 5, the mobile biometric data collection device 400 also preferably logs information about the access attempt—including any information that the servicer was prompted to enter—and time and location information about the attempted or actual access. If the mobile biometric data collection device 400 is equipped with a cell phone communications circuit or wireless Internet communications circuit, it will attempt to establish communications with a central administrative station to upload attempted access and audit information to the central administrative station.

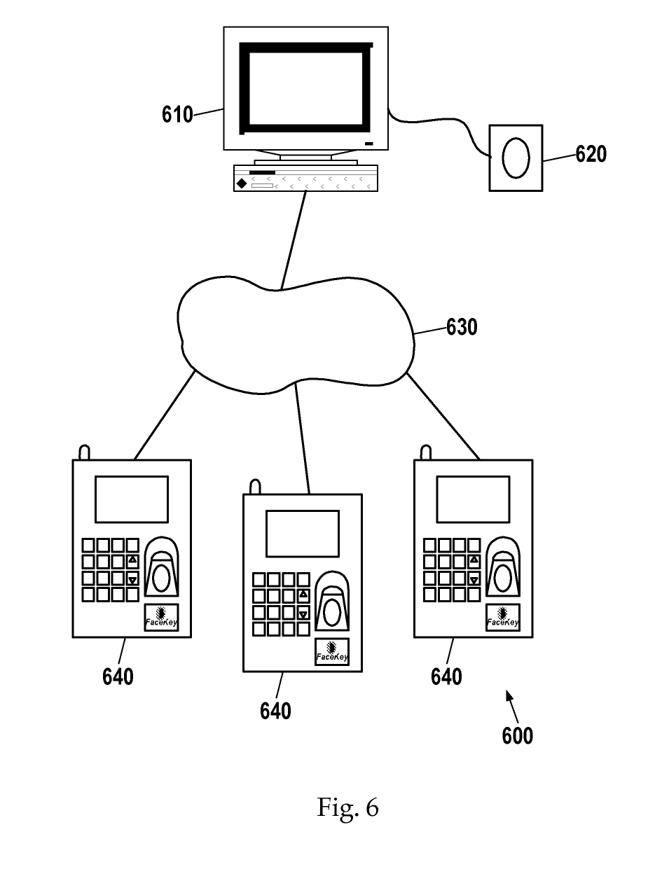

FIG. 6 is a block diagram of one embodiment of a biometric access control system 600 for a plurality of currency-handling machines, including an enrollment and registration station 610 for servicers. Servicers are enrolled at the enrollment and registration station 610 (which may also serve as the central administrative station noted in connection with FIG. 4) by entering in information about the servicer, including the servicer's name, address, phone number, employee number, social security number, personal identification number, and the like, uploading one or more personal photographs for the servicer, and sensing one or more biometric characteristics of the servicer, such as the servicer's fingerprint(s), facial profile, voice characteristics, or handwriting characteristics. The enrollment and registration station 610 then creates biometric reference templates out of the sensed biometric characteristics and stores the templates, along with associated information about the servicer, in a database.

In systems in which each mobile biometric data collection device 640 is intended to retain only a single servicer's biometric templates, the station 610 downloads the templates associated with a servicer directly to the mobile biometric data collection device 640 via a direct connection. In systems in which a plurality of mobile biometric data collection devices 640 are intended to store a plurality of servicers' biometric templates, the station 610 connects to the devices 640 via a wired or wireless network 630.

Although the foregoing specific details describe various embodiments of the invention, persons reasonably skilled in the art will recognize that various changes may be made in the details of the apparatus or method of this invention without departing from the spirit and scope of the invention as defined in the appended claims.

The present invention includes several independently meritorious inventive aspects and advantages. Unless compelled by the claim language itself, the claims should not be construed to be limited to structures that incorporate all of the inventive aspects, or enjoy all of the advantages, disclosed herein.

It is well established that the claims of the patent serve an important public notice function to potential competitors—enabling them to not only determine what is covered, but also what is not covered—by the patent. And a number of Federal Circuit decisions have emphasized the importance of discerning the patentee's intent—as expressed in the specification—in construing the claims of the patent.

But defendants in patent infringement suits—while arguing the importance of this public notice function—often seek strained and uncharitable constructions of the claims that would render them either nonsensical, too narrow to have any significant value, or so broad that the claim is anticipated by the prior art. Counsel for defendants routinely flog minor grammatical, typographical, or syntactical flaws, if any, in the claims or specification, forgetting that patents are generally written by—and for—engineers and technicians, not by and for grammatical perfectionists and English language PhD's. Furthermore, defendants frequently misconstrue the specification and prosecution history in claim construction briefs and hearings in an effort to import contrived and novel limitations into the construction of the claims. They also frequently strive to—in essence—rewrite the claims so that they do not cover the accused device.

Accordingly, I wish to make my intentions clear—and at the same time put potential competitors on clear public notice. It is my intent that the claims receive a liberal construction and be interpreted to uphold and not destroy the right of the inventor. It is my intent that the claim terms be construed in a charitable and common-sensical manner, in a manner that encompasses the embodiments disclosed in the specification and drawings without incorporating unrecited, unnecessary limitations. It is my intent that the claim terms be construed as broadly as practicable while preserving the validity of the claims. It is my intent that the claim terms be construed in a manner consistent with the context of the overall claim language and the specification, without importing extraneous limitations from the specification or other sources into the claims, and without confining the scope of the claims to the exact representations depicted in the specification or drawings. It is also my intent that not each and every term of the claim be systematically defined and rewritten. Claim terms and phrases should be construed only to the extent that it will provide helpful, clarifying guidance to the jury, or to the extent needed to resolve a legitimate, good faith dispute that is material to the questions of validity or infringement. Otherwise, simple claim terms and phrases should be presented to the jury without any potentially confusing and difficult-to-apply definitional construction.

It is also to be understood that the terminology employed in the Summary of the Invention and Detailed Description sections of this application is for the purpose of describing particular embodiments. Unless the context clearly demonstrates otherwise, is not intended to be limiting. In this specification and the appended claims, the singular forms “a,” “an” and “the” include plural references unless the context clearly dictates otherwise. Conversely, it is contemplated that the claims may be drafted to exclude any optional element or be further limited using exclusive terminology as “solely,” “only” and the like in connection with the recitation of claim elements or by use of a “negative” limitation. It is also contemplated that any optional feature of the inventive variations described herein may be set forth and claimed independently, or in combination with any one or more of the features described herein.

The headquarters building of the World Intellectual Property Organization bears the following inscription: “Human genius is the source of all works of art and invention; these works are the guarantee of a life worthy of me; it is the duty of the State to ensure with diligence the protection of the arts and inventions.” It is my intent that the claims of this patent be construed—and ultimately enforced, if necessary—in a manner worthy of this mandate.

I claim:

1. An access-controlled currency-handling machine comprising:
a currency repository that holds currency received and/or dispensed by the currency-handling machine;
a door that, when opened or removed, provides access to the currency repository;
an electronic lock mechanism operable to unlock the door to thereby provide a servicer attempting to obtain access to the currency repository with access to the currency repository;
a digital authentication device installed within the currency-handling machine, wherein the digital authentication device is operable to send a signal to cause the electronic lock mechanism to unlock the door;
the digital authentication device having a communications interface operable to receive a biometric reference template and a biometric sample from a mobile biometric data collection device carried by the servicer; and
the digital authentication device having a processor operable to compare the biometric reference template with the biometric sample to authenticate the servicer attempting to obtain access to the currency repository and, upon identifying a match, to send a signal to cause the electronic mechanism to unlock the door.

2. The access-controlled currency-handing machine of claim 1, wherein the access-controlled currency-handling machine is a vending machine that dispenses merchandise or provides amusement to customers that insert a designated amount of currency into the machine.

3. The access-controlled currency-handing machine of claim 1, wherein the access-controlled currency-handling machine is a refrigerated beverage vending machine that dispenses cold beverages to customers that insert a designated amount of currency into the machine.

4. The access-controlled currency-handing machine of claim 1, wherein the access-controlled currency-handling machine is a snack food vending machine that dispenses snack foods to customers that insert a designated amount of currency into the machine.

5. The access-controlled currency-handing machine of claim 1, wherein the access-controlled currency-handling machine is a copy machine that makes copies for customers that insert a designated amount of currency into the machine.

6. The access-controlled currency-handing machine of claim 1, wherein the access-controlled currency-handling machine is a parking meter that provides a user that inserts a designated amount of currency into the machine with authority to use a parking space.

7. The access-controlled currency-handing machine of claim 1, wherein the access-controlled currency-handling machine is a gambling machine that enables a player to gamble money that the player inserts into the machine.

8. A biometric access control system for a currency-handling machine having a currency repository that holds currency received and/or dispensed by the currency-handling machine and a door, that when opened or removed, provides access to the currency repository, an electronic lock mechanism operable to unlock the door to thereby provide a servicer attempting to obtain access to the currency repository with access to the currency repository, and a digital authentication device installed within the currency-handling machine, wherein the digital authentication device is operable to send a signal to cause the electronic lock mechanism to unlock the door, the biometric access control system comprising:
a mobile biometric data collection device carried by the servicer;
a memory module contained within the mobile biometric data collection device, the memory module being adapted to retain a biometric reference template of a currency-handling machine servicer;
a biometric sensor built into the mobile biometric data collection device, the biometric sensor being adapted to sense a biometric characteristic of the servicer for subsequent comparison with the biometric reference template; and
a communications interface operable to communicate information from the mobile biometric data collection device to the digital authentication device of the currency-handling machine, which information is processed by the digital authentication device to provide or deny access to the currency repository.

9. The biometric access control system of claim 8, further comprising:
a processor inside the mobile biometric data collection device operable to compare the biometric reference template with the sensed biometric characteristic of the servicer and, upon identifying a match, to transfer an encrypted key to the digital authentication device for obtaining access to the currency repository.

10. The biometric access control system of claim 8, further comprising:
a processor inside the digital authentication device operable to compare the biometric reference template with the sensed biometric characteristic of the servicer and, upon identifying a match, to send a signal to cause the electronic lock mechanism to unlock the door, thereby providing the servicer with access to the currency repository.

11. The biometric access control system of claim 8, wherein the mobile biometric data collection device is operable to log attempts to access a currency-handling machine with an indicator of the identity of a person attempting to access the currency-handling machine.

12. The biometric access control system of claim 11, wherein the indicator of the identity of the person attempting to access the currency-handling machine is biometric information derived from a biometric characteristic of the person sensed by the biometric sensor.

13. The biometric access control system of claim 11, further comprising a clock built into the mobile biometric data collection device, and wherein the mobile biometric data collection device is operable to log attempts to access the currency-handling machine with the time of the attempt.

14. The biometric access control system of claim 11, further comprising a GPS receiver communicatively coupled to the mobile biometric data collection device, and wherein the mobile biometric data collection device is operable to log attempts to access the currency-handling machine with the time and place of the attempt.

15. The biometric access control system of claim 11, wherein the mobile biometric data collection device is operable to log attempts to access a currency-handling machine with a digital identifier, received from the digital authentication device, of the currency-handling machine.

16. The biometric access control system of claim 8, further comprising a keypad and a digital display built into the mobile biometric data collection device, and wherein the mobile biometric data collection device prompts the servicer to enter information related to the attempt to access the currency repository of the currency-handling machine.

17. The biometric access control system of claim 16, wherein the mobile biometric data collection device is operable to receive and store information collected from the digital authentication device concerning the amount of money held in the currency repository.

18. A method of servicing a currency-handling machine equipped with a currency repository and a digital authentication device adapted to provide access to the currency repository, the method comprising:
(a) providing a mobile biometric data collection device having a memory module storing a biometric reference template of a currency-handling machine servicer and a biometric sensor adapted to sense a biometric characteristic of the servicer for subsequent comparison with the biometric reference template;
(b) establishing a communications link between the mobile biometric data collection device and the digital authentication device of the currency-handling machine;
(c) sensing a biometric characteristic from the servicer;
(d) comparing the sensed biometric characteristic with the biometric reference template; and
(e) if the sensed biometric characteristic matches the biometric reference template, providing the servicer with access to the currency repository of the currency-handling machine.

19. The method of claim 18, further comprising carrying the mobile biometric data collection device along a service route in order to service a group of currency-handling machines, and repeating the actions of (b)-(e) for each currency-handling machine serviced along the service route.

20. The method of claim 18, wherein the mobile biometric data collection device transfers both the sensed biometric characteristic and the biometric reference template to the digital authentication device, and wherein the digital authentication device performs the comparison of the sensed biometric characteristic with the biometric reference template.
